(19) United States
(12) Patent Application Publication
(10) Pub. No.: US 2013/0150278 A1
(43) Pub. Date: Jun. 13, 2013

(54) DETERGENT COMPOSITION

(71) Applicants: Euan John Magennis, Tyne and Wear (GB); Kerry Louise Swabey, Newcastle upon (GB)

(72) Inventors: Euan John Magennis, Tyne and Wear (GB); Kerry Louise Swabey, Newcastle upon (GB)

(21) Appl. No.: 13/564,814

(22) Filed: Aug. 2, 2012

(30) Foreign Application Priority Data
Dec. 10, 2011 (EP) 11184921.2

(51) Int. Cl. C11D 1/37; C11D 3/42; C11D 3/06; C11D 3/37; C11D 3/386; C11D 3/08

(52) U.S. Cl. 510/320; 510/352; 510/324

(57) ABSTRACT

The present invention is to a detergent composition comprising an anionic surfactant system, wherein the anionic surfactant system comprises;
i) An alkyl sulfate surfactant of formula R₁—O—SO₃⁻M⁺, with R₁ being a linear or branched, substituted or unsubstituted, optionally alkoxylated, C₁₀-C₁₆ alkyl and with M⁺ being a proton or a cation which provides charge neutrality, and
ii) A linear or branched, substituted or unsubstituted C₁₀-C₁₆ alcohol ethoxylate sulfate surfactant having an average degree of ethoxylation of from 0.5 to 3 having a proton or a cation which provides charge neutrality.

### FIELD OF THE INVENTION

The present invention relates to detergent compositions comprising an anionic surfactant system which exhibit enhanced greasy stain removal from fabrics during the wash.

### BACKGROUND TO THE INVENTION

Anionic surfactants are known for their cleaning detergent properties and, accordingly, have been used for years in laundry detergent compositions to remove the soil of the fabrics during the wash.

Although anionic surfactants are used to remove a broad spectrum of stains, there is a need for improved greasy stain removal.

Two broad classes of anionic surfactants used in detergent compositions are alkyl sulphate surfactants and alcohol ethoxylate sulfate surfactants. Species of these two surfactants differ in alkyl chain length and also degree of ethoxylation.

The Inventors have now surprisingly found that a detergent composition comprising an anionic surfactant system, wherein the anionic surfactant system comprises a specific alkyl sulfate surfactant having a particular alkyl chain length and a specific alcohol ethoxylate sulfate surfactant having a particular alkyl chain length and particular degree of ethoxylation provided improved greasy stain removal from fabrics during the wash.

### SUMMARY OF THE INVENTION

The present invention is to a detergent composition comprising an anionic surfactant system, wherein the anionic surfactant system comprises;
i) An alkyl sulfate surfactant of formula R₁—O—SO₃⁻M⁺, with R₁ being a linear or branched, substituted or unsubstituted, optionally alkoxylated, C₁₀-C₁₆ alkyl and with M⁺ being a proton or a cation which provides charge neutrality, and
ii) A linear or branched, substituted or unsubstituted C₁₀-C₁₆ alcohol ethoxylate sulfate surfactant having an average degree of ethoxylation of from 0.5 to 3, having a proton or a cation which provides charge neutrality.

Another aspect of the present invention is a process to clean fabrics, comprising the step of adding the detergent composition of the present invention to water to make a wash liquor and adding fabrics to the wash liquor.

Yet another aspect of the present invention is the use of a detergent of the present invention for laundering fabrics comprising greasy stains.

### DETAILED DESCRIPTION OF THE INVENTION

### Anionic Surfactant System

The detergent composition of the present invention comprises an anionic surfactant system comprising an alkyl sulfate surfactant of formula R₁—O—SO₃⁻M⁺, with R₁ being a linear or branched, substituted or unsubstituted, optionally alkoxylated, C₁₀-C₁₆ alkyl and with M⁺ being a proton or a cation which provides charge neutrality (herein referred to as an alkyl sulfate surfactant) and a linear or branched, substituted or unsubstituted C₁₀-C₁₆ alcohol ethoxylate sulfate surfactant having an average degree of ethoxylation of from 0.5 to 3, having a proton or a cation which provides charge neutrality (herein referred to as an alcohol ethoxylate sulfate surfactant).

According to one embodiment of the invention, the alkyl sulfate surfactant is not alkoxylated. Higher concentration of alkyl sulfate may be obtained if the alkyl sulfate is not alkoxylated. The compositions of the invention may also comprise alkoxylated, for example ethoxylated and/or propyloxylated, alkyl sulfate surfactant(s). The compositions of the invention may comprise both non alkoxylated and alkoxylated alkyl sulfate surfactants.

M⁺ may be a proton or a cation such as a sodium, calcium, potassium, or magnesium cation, in particular a sodium cation.

The alkyl sulphate surfactant comprises different species, which vary in chain length (ranging from C₁₀ to C₁₆). These different species may also be ethoxylated, and have different degrees of ethoxylation ranging from 0 to 6.

The alcohol ethoxylate sulphate surfactant comprises different species, which vary in both chain length (ranging from C₁₀ to C₁₆), but also in ethoxylation (ranging from 0 to 6). However, the average degree of ethoxylation of the species present is between 0.5 and 3, preferably between 1 and 2.5.

Suitable protons or cations to provide charge neutrality include sodium, calcium, potassium, or magnesium cation, in particular a sodium cation

Without wishing to be bound by theory, it is believed that a detergent composition that comprises an anionic surfactant system that comprises these two specific surfactants exhibits improved greasy stain removal from fabrics during the wash.

The anionic surfactant system comprises a mix of different surfactant species (both alkyl sulphate surfactant and also alcohol ethoxylate sulphate surfactant), having different degrees of ethoxylation and also different chain lengths. Preferably, by weight of the anionic surfactant system, between 45% and 70% of species present have a degree of ethoxylation of 0, between 14% and 26% of species present have a degree of ethoxylation of 1, between 7% and 15% of species present have a degree of ethoxylation of 2, between 4% and 8% of species present have a degree of ethoxylation of 3, between 2% and 5% of species present have a degree of ethoxylation of 4, between 1% and 3% of species present have a degree of ethoxylation of 5, and between 0.5% and 1.5% of species present have a degree of ethoxylation of 6.

In one embodiment, the anionic surfactant system comprises a mix of different surfactant species comprising by weight of the anionic surfactant system, between 45% and 70% of species having a degree of ethoxylation of 0.

In another embodiment, the anionic surfactant system comprises a mix of different surfactant species comprising by weight of the anionic surfactant system, between 14% and 26% of species having a degree of ethoxylation of 1.

In yet another embodiment, the anionic surfactant system comprises a mix of different surfactant species comprising by weight of the anionic surfactant system, between 7% and 15% of species having a degree of ethoxylation of 2.

In one embodiment, the anionic surfactant system comprises a mix of different surfactant species, wherein between 65% and 75% of the surfactant species have an alkyl chain length of C₁₂. Preferably, the C₁₂ surfactant species comprise surfactant species that differ in degree of ethoxylation, wherein, between 65% to 67% of the C₁₂ species have a degree of ethoxylation of 0, between 15% and 17% of the C₁₂ species have a degree of ethoxylation of 1, between 8% and 10% of the C₁₂ species have a degree of ethoxylation of 2, between 4% and 6% of the C₁₂ species have a degree of ethoxylation of 3, between 2% and 4% of the C₁₂ species have a degree of ethoxylation of 4, and between 0.5% and 2% of the C₁₂ species have a degree of ethoxylation of 5.

In one embodiment, the anionic surfactant system comprises a mix of different surfactant species, wherein between 22% and 30% of the surfactant species have an alkyl chain length of C₁₄. Preferably, the C₁₄ surfactant species comprise surfactant species that differ in degree of ethoxylation, wherein, between 63% to 65% of the C₁₄ species have a degree of ethoxylation of 0, between 14% and 16% of the C₁₄ species have a degree of ethoxylation of 1, between 9% and 11% of the C₁₄ species have a degree of ethoxylation of 2, between 4% and 6% of the C₁₄ species have a degree of ethoxylation of 3, between 2% and 3.5% of the C₁₄ species have a degree of ethoxylation of 4, and between 2% and 3.5% of the C₁₄ species have a degree of ethoxylation of 5.

In another embodiment, between 0.1% and 0.3% by weight of the anionic surfactant system comprises surfactant species having a chain length of C₁₀ and an ethoxylation of 0; between 40% and 50% by weight of the anionic surfactant system comprises surfactant species having a chain length of C₁₂ and an ethoxylation of 0; between 10% and 20% by weight of the anionic surfactant system comprises surfactant species having a chain length of C₁₄ and an ethoxylation of 0; between 1.5% and 5% by weight of the anionic surfactant system comprises surfactant species having a chain length of C₁₆ and an ethoxylation of 0; between 8% and 14% by weight of the anionic surfactant system comprises surfactant species having a chain length of C₁₂ and an ethoxylation of 1; between 2% and 6% by weight of the anionic surfactant system comprises surfactant species having a chain length of C₁₄ and an ethoxylation of 1; between 0.5% and 1% by weight of the anionic surfactant system comprises surfactant species having a chain length of C₁₆ and an ethoxylation of 1; between 4% and 8% by weight of the anionic surfactant system comprises surfactant species having a chain length of C₁₂ and an ethoxylation of 2; between 1% and 4% by weight of the anionic surfactant system comprises surfactant species having a chain length of C₁₄ and an ethoxylation of 2; between 0.5% and 1% by weight of the anionic surfactant system comprises surfactant species having a chain length of C₁₆ and an ethoxylation of 2; between 2% and 5% by weight of the anionic surfactant system comprises surfactant species having a chain length of C₁₂ and an ethoxylation of 3; between 0.5% and 3% by weight of the anionic surfactant system comprises surfactant species having a chain length of C₁₄ and an ethoxylation of 3; between 1% and 3% by weight of the anionic surfactant system comprises surfactant species having a chain length of C₁₂ and an ethoxylation of 4; between 0.5% and 1.5% by weight of the anionic surfactant system comprises surfactant species having a chain length of C₁₄ and an ethoxylation of 4; between 0.5% and 1.5% by weight of the anionic surfactant system comprises surfactant species having a chain length of C₁₂ and an ethoxylation of 5; between 0.5% and 1.5% by weight of the anionic surfactant system comprises surfactant species having a chain length of C₁₄ and an ethoxylation of 5.

Without wishing to be bound by theory, it is believed that the specific overall distribution of alkyl chain length and degree of ethoxylation of the surfactant species within the anionic surfactant system provides enhanced greasy stain removal from fabrics during the wash.

In one embodiment, the ratio of the alkyl sulfate surfactant to the alcohol ethoxylate sulfate surfactant is between 1:1 and 5:1. In another embodiment, the ratio of the alkyl sulfate surfactant to the alcohol ethoxylate sulfate surfactant is between 1:1 and 3:1.

Preferably, the detergent composition comprises from 0.5% to 20% by weight of the detergent composition of the anionic surfactant system, preferably, from 1% to 10%, even more preferably from 1.5% to 5%, most preferably from 2% to 4% by weight of the detergent composition of the anionic surfactant system.

### Other Surfactants

The detergent composition of the present invention may comprise one or more additional surfactant(s). The additional surfactant(s) may be selected from nonionic surfactants, other anionic surfactants, cationic surfactants, ampholytic surfactants, zwitterionic surfactants, semi-polar nonionic surfactants and mixtures thereof.

NON-IONIC DETERSIVE SURFACTANT—

The detergent compositions of the invention may comprise non-ionic surfactant. Where present the non-ionic detersive surfactant(s) is generally present in amounts of from 0.5% to 20%, or from 2% to 4% by weight of the detergent composition.

The non-ionic detersive surfactant can be selected from the group consisting of: alkyl polyglucoside and/or an alkyl alkoxylated alcohol; C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 35, as described in more detail in U.S. Pat. No. 6,153,577, U.S. Pat. No. 6,020,303 and U.S. Pat. No. 6,093,856; alkylcelluloses as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

CATIONIC DETERSIVE SURFACTANT—

The detergent composition may comprise a cationic detersive surfactant. When present, typically the detergent composition comprises from 0.1% to 10%, or from 1% to 2% by weight of the detergent composition of cationic detersive surfactant.

Suitable cationic detersive surfactants are alkyl pyridinium compounds, alkyl quaternary ammonium compounds, alkyl quaternary phosphonium compounds, and alkyl ternary sulphonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium surfactants as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof.

Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

SECONDARY ALCOHOL-BASED DETERSIVE SURFACTANT—

Preferably, the detergent composition comprises secondary alcohol-based detersive surfactant having the formula;

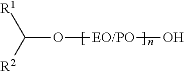

wherein R¹=linear or branched, substituted or unsubstituted, saturated or unsaturated C₂₋₈ alkyl;
wherein R²=linear or branched, substituted or unsubstituted, saturated or unsaturated C₂₋₈ alkyl,
wherein the total number of carbon atoms present in R¹+R² moieties is in the range of from 7 to 13;
wherein EO/PO are alkoxy moieties selected from ethoxy, propoxy, or mixtures thereof,
preferably the EO/PO alkoxyl moieties are in random or block configuration;
wherein n is the average degree of alkoxylation and is in the range of from 4 to 10.

Preferably, the detergent composition comprises primary alcohol-based detersive surfactant having the formula;

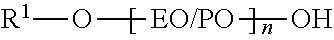

wherein R¹=linear or branched, substituted or unsubstituted, saturated or unsaturated C₁₀₋₁₈ alkyl;
wherein EO/PO are alkoxy moieties selected from ethoxy, propoxy, or mixtures thereof,
preferably the EO/PO alkoxyl moieties are in random or block configuration;
wherein n is the average degree of alkoxylation and is in the range of from 4 to 10.

### Builder

The detergent composition may comprise one or more builders. When a builder is used, the detergent composition will typically comprise from 1% to about 40%, typically from 2 to 25%, or even from about 5% to about 20%, or from 8 to 15% by weight of the detergent composition of builder.

The detergent compositions of the present invention may comprise from 0% to 20%, in particular less than 15% or less than 10%, or less than 5% by weight of the detergent composition of zeolite. In particular, the detergent composition may comprise from 0% to 20%, in particular less than 15% or less than 10%, or less than 5% by weight of the detergent composition of aluminosilicate builder(s).

The detergent composition of the present invention may comprise from 0 to 20%, in particular less than 15% or 10%, for example less than 5% by weight of the detergent composition of phosphate builder and/or silicate builder and/or zeolite builder.

The detergent composition of the present invention may comprise from 0 to 20%, in particular less than 15% or 10%, for example less than 5% by weight of the detergent composition of phosphate builder and/or zeolite builder.

The detergent compositions of the present invention may comprise from 0 to 20%, in particular less than 15% or 10%, for example less than 5% by weight of the detergent composition of sodium carbonate.

Builders include, but are not limited to, the alkali metal, ammonium and alkanolammonium salts of polyphosphates, alkali metal silicates, layered silicates, such as SKS-6 of Clariant®, alkaline earth and alkali metal carbonates, aluminosilicate builders, such as zeolite, and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, fatty acids, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

The total amount of phosphate builder(s), aluminosilicate builder(s), polycarboxylic acid builder(s), and additional silicate builder(s) in the detergent composition may be comprised from 0 to 25%, or even from 1 to 20%, in particular from 1 to 15%, especially from 2 to 10%, for example from 3 to 5%, by weight of the detergent composition.

The detergent composition may further comprise any other supplemental builder(s), chelant(s), or, in general, any material which will remove calcium ions from solution by, for example, sequestration, complexation, precipitation or ion exchange. In particular the composition may comprise materials having at a temperature of 25° C. and at a 0.1M ionic strength a calcium binding capacity of at least 50 mg/g and a calcium binding constant log K Ca²⁺ of at least 3.50.

In the detergent composition of the invention, the total amount of phosphate builder(s), aluminosilicate builder(s), polycarboxylic acid builder(s), additional silicate builder(s), and other material(s) having a calcium binding capacity superior to 50 mg/g and a calcium binding constant higher than 3.50 in the composition may be comprised from 0 to 25%, or even from 1 to 20%, in particular from 1 to 15%, especially from 2 to 10%, for example from 3 to 5%, by weight of the detergent composition.

### Polyethylene Glycol Polymer

In one embodiment, the detergent composition of the present invention comprises a polyethylene glycol polymer. Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22.

### Cellulosic Polymer

In one embodiment, the detergent composition may comprise cellulosic polymers. Preferably, the cellulosic polymers are selected from the group comprising alkyl cellulose, alkyl alkoxyalkyl cellulose, carboxyalkyl cellulose, alkyl carboxyalkyl, and any combination thereof. Suitable cellulosic polymers are selected from carboxymethyl cellulose, methyl cellulose, methyl hydroxyethyl cellulose, methyl carboxymethyl cellulose, and mixtures thereof. The carboxymethyl cellulose can have a degree of carboxymethyl substitution from 0.5 to 0.9 and a molecular weight from 100,000 Da to 300,000 Da. Another suitable cellulosic polymer is hydrophobically modified carboxymethyl cellulose, such as Finnfix SH-1 (CP Kelco).

Other suitable cellulosic polymers may have a degree of substitution (DS) of from 0.01 to 0.99 and a degree of blockiness (DB) such that either DS+DB is of at least 1.00 or DB+2DS-DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

### Hueing Agent

The detergent composition of the present invention may comprise a hueing agent. The hueing agent (also defined herein as hueing dye) is typically formulated to deposit onto fabrics from the wash liquor so as to improve fabric whiteness perception. The hueing agent is typically blue or violet. It may be suitable that the hueing dye(s) have a peak absorption wavelength of from 550 nm to 650 nm, or from 570 nm to 630 nm. The hueing agent may be a combination of dyes which together have the visual effect on the human eye as a single dye having a peak absorption wavelength on polyester of from 550 nm to 650 nm, or from 570 nm to 630 nm. This may be provided for example by mixing a red and green-blue dye to yield a blue or violet shade.

Dyes are typically coloured organic molecules which are soluble in aqueous media that contain surfactants. Dyes maybe selected from the classes of basic, acid, hydrophobic, direct and polymeric dyes, and dye-conjugates. Suitable polymeric hueing dyes are commercially available, for example from Milliken, Spartanburg, S.C., USA.

Examples of suitable dyes are violet DD, direct violet 7, direct violet 9, direct violet 11, direct violet 26, direct violet 31, direct violet 35, direct violet 40, direct violet 41, direct violet 51, direct violet 66, direct violet 99, acid violet 50, acid blue 9, acid violet 17, acid black 1, acid red 17, acid blue 29, solvent violet 13, disperse violet 27 disperse violet 26, disperse violet 28, disperse violet 63 and disperse violet 77, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141, thiazolium dyes, reactive blue 19, reactive blue 163, reactive blue 182, reactive blue 96, Liquitint® Violet CT (Milliken, Spartanburg, USA) and Azo-CM-Cellulose (Megazyme, Bray, Republic of Ireland). Other suitable hueing agents are hueing dye-photobleach conjugates, such as the conjugate of sulphonated zinc phthalocyanine with direct violet 99. A particularly suitable hueing agent is a combination of acid red 52 and acid blue 80, or the combination of direct violet 9 and solvent violet 13.

### Brightener

In one embodiment, the detergent composition of the present invention comprises a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The detergent composition preferably comprises C.I. fluorescent brightener 260 in alpha-crystalline form having the following structure:

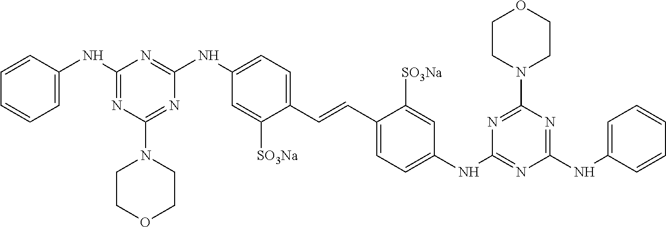

The C.I. fluorescent brightener 260 is preferably predominantly in alpha-crystalline form. Predominantly in alpha-crystalline form means that preferably at least 50 wt %, or at least 75 wt %, or even at least 90 wt %, or at least 99 wt %, or even substantially all, of the C.I. fluorescent brightener 260 is in alpha-crystalline form.

The brightener is typically in micronized particulate form, having a weight average primary particle size of from 3 to 30 micrometers, preferably from 3 micrometers to 20 micrometers, and most preferably from 3 to 10 micrometers.

The detergent composition may comprises C.I. fluorescent brightener 260 in beta-crystalline form, and preferably the weight ratio of: (i) C.I. fluorescent brightener 260 in alpha-crystalline form, to (ii) C.I. fluorescent brightener 260 in beta-crystalline form is at least 0.1, preferably at least 0.6.

BE680847 relates to a process for making C.I fluorescent brightener 260 in alpha-crystalline form.

### Flocculating Aid

The detergent composition may further comprise a flocculating aid. Typically, the composition comprises at least 0.3% by weight of the detergent composition of a flocculating aid. The composition may also be substantially free of flocculating aid. Typically, the flocculating aid is polymeric. Typically the flocculating aid is a polymer comprising monomer units selected from the group consisting of ethylene oxide, acrylamide, acrylic acid and mixtures thereof. Typically the flocculating aid is a polyethyleneoxide. Typically the flocculating aid has a molecular weight of at least 100,000 Da, in particular from 150,000 Da to 5,000,000 Da or even from 200,000 Da to 700,000 Da.

### Bleach

The detergent composition may comprise bleach. Alternatively, the composition may be substantially free of bleach; substantially free means “no deliberately added”. Suitable bleach includes bleach activators, sources of available oxygen, pre-formed peracids, bleach catalysts, reducing bleach, and any combination thereof. If present, the bleach, or any component thereof, for example the pre-formed peracid, may be coated, such as encapsulated, or clathrated, such as with urea or cyclodextrin.

BLEACH ACTIVATOR:

Suitable bleach activators include: tetraacetylethylenediamine (TAED); oxybenzene sulphonates such as nonanoyl oxybenzene sulphonate (NOBS), caprylamidononanoyl oxybenzene sulphonate (NACA-OBS), 3,5,5-trimethyl hexanoyloxybenzene sulphonate (Iso-NOBS), dodecyl oxybenzene sulphonate (LOBS), and any mixture thereof; caprolactams; pentaacetate glucose (PAG); nitrile quaternary ammonium; imide bleach activators, such as N-nonanoyl-N-methyl acetamide; and any mixture thereof.

SOURCE OF AVAILABLE OXYGEN:

A suitable source of available oxygen (AvOx) is a source of hydrogen peroxide, such as percarbonate salts and/or perborate salts, such as sodium percarbonate. The source of peroxygen may be at least partially coated, or even completely coated, by a coating ingredient such as a carbonate salt, a sulphate salt, a silicate salt, borosilicate, or any mixture thereof, including mixed salts thereof. Suitable percarbonate salts can be prepared by a fluid bed process or by a crystallization process. Suitable perborate salts include sodium perborate mono-hydrate (PB1), sodium perborate tetra-hydrate (PB4), and anhydrous sodium perborate which is also known as fizzing sodium perborate. Other suitable sources of AvOx include persulphate, such as oxone. Another suitable source of AvOx is hydrogen peroxide.

PRE-FORMED PERACID:

A suitable pre-formed peracid is N,N-pthaloylamino peroxycaproic acid (PAP).

BLEACH CATALYST:

Suitable bleach catalysts include oxaziridinium-based bleach catalysts, transition metal bleach catalysts and bleaching enzymes.

OXAZIRIDINIUM-BASED BLEACH CATALYST:

A suitable oxaziridinium-based bleach catalyst has the formula:

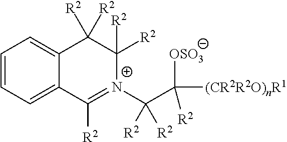

wherein: R¹ is selected from the group consisting of: H, a branched alkyl group containing from 3 to 24 carbons, and a linear alkyl group containing from 1 to 24 carbons; R¹ can be a branched alkyl group comprising from 6 to 18 carbons, or a linear alkyl group comprising from 5 to 18 carbons, R¹ can be selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons; optionally R² is independently selected from H and methyl groups; and n is an integer from 0 to 1.

TRANSITION METAL BLEACH CATALYST:

The detergent composition may include transition metal bleach catalyst, typically comprising copper, iron, titanium, ruthenium, tungsten, molybdenum, and/or manganese cations. Suitable transition metal bleach catalysts are manganese-based transition metal bleach catalysts.

### Fluorescent Whitening Agent

The detergent composition may contain components that may tint articles being cleaned, such as fluorescent whitening agent. When present, any fluorescent whitening agent suitable for use in a detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives.

Typical fluorescent whitening agents are Parawhite KX, supplied by Paramount Minerals and Chemicals, Mumbai, India; Tinopal® DMS and Tinopal® CBS available from Ciba-Geigy AG, Basel, Switzerland. Tinopal® DMS is the disodium salt of 4,4′-bis-(2-morpholino-4 anilino-s-triazin-6-ylamino)stilbene disulphonate. Tinopal® CBS is the disodium salt of 2,2′-bis-(phenyl-styryl)disulphonate.

### Fabric Hueing Agent

The detergent composition may comprise a fabric hueing agent. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof.

### Polymeric Dispersing Agents

The detergent compositions of the present invention can contain additional polymeric dispersing agents. These polymeric dispersing agents, if included, are typically at levels up to about 5%, typically from about 0.2% to about 2.5%, more typically from about 0.5% to about 1.5% by weight of the detergent composition. Suitable polymeric dispersing agents, include polymeric polycarboxylates, substituted (including quarternized and oxidized) polyamine polymers, and polyethylene glycols, such as: acrylic acid-based polymers having an average molecular of about 2,000 to about 10,000; acrylic/maleic-based copolymers having an average molecular weight of about 2,000 to about 100,000 and a ratio of acrylate to maleate segments of from about 30:1 to about 1:1; maleic/acrylic/vinyl alcohol terpolymers; polyethylene glycol (PEG) having a molecular weight of about 500 to about 100,000, typically from about 1,000 to about 50,000, more typically from about 1,500 to about 10,000; and water soluble or dispersible alkoxylated polyalkyleneamine materials.

### Polyester Soil Release Polymers

In one embodiment, the detergent composition comprises a polyester soil release polymer. Suitable polyester soil release polymers have a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO-]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or any mixture thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group. Suitable polyester soil release polymers are terephthalate polymers having the structure of formula (I) or (II) above.

Suitable polyester soil release polymers include the Repel-o-tex series of polymers such as Repel-o-tex SF2 (Rhodia) and/or the Texcare series of polymers such as Texcare SRA300 (Clariant).

### Enzyme

In one embodiment, the detergent composition comprises an enzyme. Suitable enzymes include proteases, amylases, cellulases, lipases, xylogucanases, pectate lyases, mannanases, bleaching enzymes, cutinases, and mixtures thereof.

For the enzymes, accession numbers and IDs shown in parentheses refer to the entry numbers in the databases Genbank, EMBL and/or Swiss-Prot. For any mutations, standard 1-letter amino acid codes are used with a * representing a deletion. Accession numbers prefixed with DSM refer to micro-organisms deposited at Deutsche Sammlung von Mikroorganismen and Zellkulturen GmbH, Mascheroder Weg 1b, 38124 Brunswick (DSMZ).

PROTEASE:

The composition may comprise a protease. Suitable proteases include metalloproteases and/or serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, Bacillus alkalophilus (P27963, ELYA_BACAO), Bacillus subtilis, Bacillus amyloliquefaciens (P00782, SUBT_BACAM), Bacillus pumilus (P07518) and Bacillus gibsonii (DSM14391).

(b) trypsin-type or chymotrypsin-type proteases, such as trypsin (e.g. of porcine or bovine origin), including the Fusarium protease and the chymotrypsin proteases derived from Cellumonas (A2RQE2).

(c) metalloproteases, including those derived from Bacillus amyloliquefaciens (P06832, NPRE_BACAM).

Suitable proteases include those derived from Bacillus gibsonii or Bacillus Lentus such as subtilisin 309 (P29600) and/or DSM 5483 (P29599).

Suitable commercially available protease enzymes include: those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Genencor International; those sold under the tradename Opticlean® and Optimase® by Solvay Enzymes; those available from Henkel/Kemira, namely BLAP (P29599 having the following mutations S99D+S101 R+S103A+V104I+G159S), and variants thereof including BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D) all from Henkel/Kemira; and KAP (Bacillus alkalophilus subtilisin with mutations A230V+S256G+S259N) from Kao.

AMYLASE:

Suitable amylases are alpha-amylases, including those of bacterial or fungal origin. Chemically or genetically modified mutants (variants) are included. A suitable alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, sp 707, DSM 9375, DSM 12368, DSMZ no. 12649, KSM AP1378, KSM K36 or KSM K38. Suitable amylases include:

(a) alpha-amylase derived from Bacillus licheniformis (P06278, AMY_BACLI), and variants thereof, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

(b) AA560 amylase (CBU30457, HD066534) and variants thereof, especially the variants with one or more substitutions in the following positions: 26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, optionally that also contain the deletions of D183* and G184*.

(c) variants exhibiting at least 90% identity with the wild-type enzyme from Bacillus SP722 (CBU30453, HD066526), especially variants with deletions in the 183 and 184 positions.

Suitable commercially available alpha-amylases are Duramyl®, Liquezyme® Termamyl®, Termamyl Ultra®, Natalase®, Supramyl®, Stainzyme®, Stainzyme Plus®, Fungamyl® and BAN® (Novozymes A/S), Bioamylase® and variants thereof (Biocon India Ltd.), Kemzym® AT 9000 (Biozym Ges. m.b.H, Austria), Rapidase®, Purastar®, Optisize HT Plus®, Enzysize®, Powerase® and Purastar Oxam®, Maxamyl® (Genencor International Inc.) and KAM® (KAO, Japan). Suitable amylases are Natalase®, Stainzyme® and Stainzyme Plus®.

CELLULASE:

The composition may comprise a cellulase. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, and Carezyme® (Novozymes A/S), Clazinase®, and Puradax HA® (Genencor International Inc.), and KAC-500(B)® (Kao Corporation).

The cellulase can include microbial-derived endoglucanases exhibiting endo-beta-1,4-glucanase activity (E.C. 3.2.1.4), including a bacterial polypeptide endogenous to a member of the genus Bacillus sp. AA349 and mixtures thereof. Suitable endoglucanases are sold under the tradenames Celluclean® and Whitezyme® (Novozymes A/S, Bagsvaerd, Denmark).

The composition may comprise a cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

Suitable cellulases may also exhibit xyloglucanase activity, such as Whitezyme®.

LIPASE:

The detergent composition may comprise a lipase. Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus), or from H. insolens, a Pseudomonas lipase, e.g., from P. alcaligenes or P. pseudoalcaligenes, P. cepacia, P. stutzeri, P. fluorescens, Pseudomonas sp. strain SD 705, P. wisconsinensis, a Bacillus lipase, e.g., from B. subtilis, B. stearothermophilus or B. pumilus.

The lipase may be a “first cycle lipase”, optionally a variant of the wild-type lipase from Thermomyces lanuginosus comprising T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Suitable lipases would include those sold under the tradenames Lipex®, Lipolex® and Lipoclean® by Novozymes, Bagsvaerd, Denmark.

The composition may comprise a variant of Thermomyces lanuginosa (O59952) lipase having >90% identity with the wild type amino acid and comprising substitution(s) at T231 and/or N233, optionally T231R and/or N233R.

XYLOGLUCANASE:

Suitable xyloglucanase enzymes may have enzymatic activity towards both xyloglucan and amorphous cellulose substrates. The enzyme may be a glycosyl hydrolase (GH) selected from GH families 5, 12, 44 or 74. The glycosyl hydrolase selected from GH family 44 is particularly suitable. Suitable glycosyl hydrolases from GH family 44 are the XYG1006 glycosyl hydrolase from Paenibacillus polyxyma (ATCC 832) and variants thereof.

PECTATE LYASE:

Suitable pectate lyases are either wild-types or variants of Bacillus-derived pectate lyases (CAF05441, AAU25568) sold under the tradenames Pectawash®, Pectaway® and X-Pect® (from Novozymes A/S, Bagsvaerd, Denmark).

MANNANASE:

Suitable mannanases are sold under the tradenames Mannaway® (from Novozymes A/S, Bagsvaerd, Denmark), and Purabrite® (Genencor International Inc., Palo Alto, Calif.).

BLEACHING ENZYME:

Suitable bleach enzymes include oxidoreductases, for example oxidases such as glucose, choline or carbohydrate oxidases, oxygenases, catalases, peroxidases, like halo-, chloro-, bromo-, lignin-, glucose- or manganese-peroxidases, dioxygenases or laccases (phenoloxidases, polyphenoloxidases). Suitable commercial products are sold under the Guardzyme® and Denilite® ranges from Novozymes. It may be advantageous for additional organic compounds, especially aromatic compounds, to be incorporated with the bleaching enzyme; these compounds interact with the bleaching enzyme to enhance the activity of the oxidoreductase (enhancer) or to facilitate the electron flow (mediator) between the oxidizing enzyme and the stain typically over strongly different redox potentials.

Other suitable bleaching enzymes include perhydrolases, which catalyse the formation of peracids from an ester substrate and peroxygen source. Suitable perhydrolases include variants of the Mycobacterium smegmatis perhydrolase, variants of so-called CE-7 perhydrolases, and variants of wild-type subtilisin Carlsberg possessing perhydrolase activity.

ENZYME STABILIZERS—

Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

### Catalytic Metal Complexes

The detergent compositions of the invention may comprise catalytic metal complexes. When present, one type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the detergent compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo [6.6.2]hexadecane.

Suitable transition metal MRLs are readily prepared by known procedures, such as taught for example in WO 00/32601, and U.S. Pat. No. 6,225,464.

### Softening System

The detergent compositions of the invention may comprise a softening agent such as clay for softening through the wash. The composition may additionally comprise a charged polymeric fabric-softening boosting component.

### Colorant

The detergent compositions of the invention may comprise a colorant, typically a dye or a pigment. Particularly, preferred dyes are those which are destroyed by oxidation during a laundry wash cycle. To ensure that the dye does not decompose during storage it is preferable for the dye to be stable at temperatures up to 40° C. The stability of the dye in the composition can be increased by ensuring that the water content of the composition is as low as possible. If possible, the dyes or pigments should not bind to or react with textile fibres. If the colorant does react with textile fibres, the colour imparted to the textiles should be destroyed by reaction with the oxidants present in laundry wash liquor. This is to avoid coloration of the textiles, especially over several washes. Particularly, preferred dyes include but are not limited to Basacid® Green 970 from BASF and Monastral blue from Albion.

### Detergent Composition

The detergent composition can be in any suitable form. The detergent composition is for example in particulate form, typically in free-flowing particulate form, although the composition may be in any liquid or solid form. The composition in solid form can be in the form of an agglomerate, granule, flake, extrudate, bar, tablet or any combination thereof. The solid composition can be made by methods such as dry-mixing, agglomerating, compaction, spray drying, pan-granulation, spheronization or any combination thereof. The solid composition typically has a bulk density of from 300 g/l to 1,500 g/l, typically from 500 g/l to 1,000 g/l.

Typically, when the detergent composition of the invention is in particulate form, the detergent composition comprises discrete particulate components comprising the anionic surfactant system. In one embodiment, discrete particles within the plurality of particles comprise both components of the anionic surfactant system. In another embodiment, discrete particles within the plurality of particles comprise only the alkyl sulfate surfactant or the alcohol ethoxylate sodium sulfate surfactant.

The detergent composition may also be in the form of a liquid, gel, paste, dispersion, typically a colloidal dispersion or any combination thereof. Liquid compositions typically have a viscosity of from 500 mPa·s to 3,000 mPa·s, when measured at a shear rate of 20 s⁻¹ at ambient conditions (20° C. and 1 atmosphere), and typically have a density of from 800 g/l to 1300 g/l. If the composition is in the form of a dispersion, then it will typically have a volume average particle size of from 1 micrometer to 5,000 micrometers, typically from 1 micrometer to 50 micrometers. Typically, a Coulter Multisizer is used to measure the volume average particle size of a dispersion.

The detergent composition may comprise a solvent. Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

The detergent composition may be in unit dose form, including not only tablets, but also unit dose pouches wherein the composition is at least partially enclosed, typically completely enclosed, by a film such as a polyvinyl alcohol film. The unit dose pouch may comprise more than one compartment. In one embodiment, both components of the anionic surfactant system are in the same compartment. In another embodiment, the alkyl sulfate surfactant is in one compartment and the alcohol ethoxylate sulfate surfactant is in a second compartment. The product form in the different compartments may be the same or different, for example one compartment may comprise a liquid and a second compartment comprises a solid.

The detergent composition may also be in the form of an insoluble substrate, for example a non-woven sheet, impregnated with detergent actives.

The detergent composition may be a laundry detergent composition capable of cleaning and/or softening fabric during a laundering process. One aspect of the present invention is a process to clean fabrics, comprising the step of adding the detergent composition of the present invention to water to make a wash liquor and added fabrics to the wash liquor. Typically, the detergent composition is formulated for use in an automatic washing machine or for hand-washing use.

### EXAMPLES

The relative grease removal capability of detergent compositions was assessed. A granular base detergent composition was prepared as follows (Table 1);

TABLE 1

| | Concentration (% by weight of |
|---|---|
| Ingredients | the detergent composition) |
| Anionic surfactant system¹ | 3% |
| Linear alkyl benzene sulfonate | 12.36% |
| Non ionic surfactant | 0.84% |
| Polymer | 1.26% |
| Sodium Carbonate | 10.81% |
| Sodium Silicate | 7.72% |
| Sodium Sulfate | Balance to 100% |

¹anionic surfactant system described in Table 2

A series of anionic surfactant systems were prepared as detailed in Table 2, and added to the base composition of Table 1 in order to make 5 separate detergent compositions.

TABLE 2

| | Sam- | Sam- | Sam- | Sam- | Sam- |
|---|---|---|---|---|---|
| | ple 1 | ple 2 | ple A | ple B | ple C |
| Ingredients | % | % | % | % | % |
| Alkyl sulphate surfactant | 66.0 | 49 | 44.1 | 16.2 | 100 |
| Alcohol ethoxylate sodium sulphate | 34.0 | 51 | | | |
| surfactant with an average degree | | | | | |
| of ethoxylation of 2.02 | | | | | |
| Alcohol ethoxylate sodium sulphate | | | 55.9 | 83.8 | |
| surfactant with an average degree | | | | | |
| of ethoxylation of 4.4 | | | | | |

Samples 1 and 2 are within the scope of the present invention and samples A-C are comparative.

The percentage of anionic surfactant species present in the samples having different levels of ethoxylation was calculated and can be seen in Table 3. The percentage value is percentage by weight of the anionic surfactant system.

TABLE 3

| Level of | Sample 1 | Sample 2 | Sample A | Sample B | Sample C |
|---|---|---|---|---|---|
| ethoxylation | % | % | % | % | % |
| 0 | 66.0 | 49 | 44.1 | 16.2 | 100 |
| 1 | 16 | 24 | 8.2 | 12.3 | |
| 2 | 8.7 | 13 | 8.5 | 12.7 | |
| 3 | 4.7 | 7 | 8.1 | 12.2 | |
| 4 | 2.7 | 4 | 7.1 | 10.7 | |
| 5 | 1.3 | 2 | 5.8 | 8.7 | |
| 6 | 0.7 | 1 | 4.9 | 7.4 | |
| 7 | | | 4.1 | 6.2 | |
| 8 | | | 3.3 | 5 | |
| 9 | | | 2.6 | 3.9 | |
| 10 | | | 1.8 | 2.7 | |
| 11 | | | 0.8 | 1.2 | |

The grease cleaning index (relative removal from a hard animal fat substrate into the detergent solution) was obtained by measuring the removal of dye-marked grease by the respective detergent samples. A test substrate was coated with a hard animal fat containing a dye. This substrate was placed into a wash liquor comprising one of the detergent samples detailed above. The system was then agitated for 10 minutes. The wash liquor was measured using a spectrophotometer before addition of the substrate and then again following 10 minutes of agitation. The results detailed in Table 3 indicate the relative grease cleaning index of each sample versus the initial wash liquor. The more dye present in the solution, the higher the grease cleaning index, indicating that more of the grease was broken down and hence more dye was released into the wash liquor.

TABLE 4

| | Sample | Sample | Sample | Sample | Sample |
|---|---|---|---|---|---|
| | 1 | 2 | A | B | C |
| Relative Grease Removal | 2730 | 2912 | 2312 | 2367 | 2202 |
| after 10 minutes | | | | | |

As can be seen from Table 4, Samples 1 and 2 (which correspond to the present invention) exhibited a higher grease removal index than samples outside of the present invention. To confirm that the relative grease removal was relevant for actual detergent performance in a consumer wash, a further experiment was conducted to compare Sample 2 and Sample A in a machine wash. The surfactant systems were single variably tested under the following conditions sample dosage of 18.4 g, wash volume of 8 L, wash temperature of 25° C., water hardness of 12 gpg, wash time of 20 minutes, rinse volume of 8 L, rinse time of 5 minutes, total load of 0.35 Kg

Fabric swatches containing lipstick stains (a surfactant sensitive greasy stain) were added washing machine and the relative stain removal versus initial unwashed stain was measured using digital imaging equipment. The test was conducted using Samples 2 versus Sample A, and was repeated with 8 different stain swatches for each detergent. Table 4 shows that for lipstick, a statistically significant performance benefit was observed between Sample 2 and Sample A. Visual panelling comprising a panel of three independent members confirmed that this was also a clearly noticeable difference.

TABLE 5

| | Sample 2 | Sample A |
|---|---|---|
| | Relative stain removal | Δ stain removal of sample 2 |
| | versus unwashed stain | versus Sample A |
| lipstick | 36.4 | −5.2 |

Table 5 shows that Sample 2 had a higher relative stain removal index than Sample A upon lipstick stains. This difference was confirmed to be a consumer noticeable difference via a visual panel.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising an anionic surfactant system, wherein the anionic surfactant system comprises;
i) An alkyl sulfate surfactant of formula R₁—O—SO₃⁻M⁺, with R₁ being a linear or branched, substituted or unsubstituted, optionally alkoxylated, C₁₀-C₁₆ alkyl and with M⁺ being a proton or a cation which provides charge neutrality, and
ii) A linear or branched, substituted or unsubstituted C₁₀-C₁₆ alcohol ethoxylate sulfate surfactant having an average degree of ethoxylation of between 0.5 and 3 and having a proton or a cation which provides charge neutrality.

2. The detergent composition of claim 1, wherein the anionic surfactant system comprises a mix of different surfactant species comprising by weight of the anionic surfactant system, between about 45% and about 70% of species having a degree of ethoxylation of 0.

3. The detergent composition of claim 1, wherein the anionic surfactant system comprises a mix of different surfactant species comprising by weight of the anionic surfactant system, between about 14% and about 26% of species having a degree of ethoxylation of 1.

4. The detergent composition of claim 1, wherein the anionic surfactant system comprises a mix of different surfactant species comprising by weight of the anionic surfactant system, between about 7% and about 15% of species having a degree of ethoxylation of 2.

5. The detergent composition of claim 1, wherein the anionic surfactant system comprises a mix of different surfactant species comprising by weight of the anionic surfactant system, between about 45% and about 70% of species having a degree of ethoxylation of 0, between about 14% and about 26% of species having a degree of ethoxylation of 1, between about 7% and about 15% of species having a degree of ethoxylation of 2, between about 4% and about 8% of species having a degree of ethoxylation of 3, between about 2% and about 5% of species having a degree of ethoxylation of 4, between about 1% and about 3% of species having a degree of ethoxylation of 5, and between about 0.5% and about 1.5% of species having a degree of ethoxylation of 6.

6. The detergent composition of claim 1, wherein the ratio of (i) to (ii) is between 1:1 and 5:1.

7. The detergent composition of claim 6, wherein the ratio of (i) to (ii) is between 1:1 and 3:1.

8. The detergent composition of claim 1, wherein the detergent composition comprises from about 0.5% to about 20% by weight of the detergent composition of the anionic surfactant system.

9. The detergent composition of claim 8, wherein the detergent composition comprises from about 1% to about 10% by weight of the detergent composition of the anionic surfactant system.

10. The detergent composition of claim 9, wherein the detergent composition comprises from about 1.5% to about 5%, by weight of the detergent composition of the anionic surfactant system.

11. The detergent composition of claim 9, wherein the detergent composition comprises from about 2% to about 4% by weight of the detergent composition of the anionic surfactant system.

12. The detergent composition of claim 1 comprising from 0% to about 20%, by weight of the detergent composition of phosphate and/or zeolite builder.

13. The detergent composition of claim 1 wherein the detergent composition comprises an enzyme and the enzyme is a lipase, the lipase being a variant of the wild-type lipase from Thermomyces lanuginosus comprising T231R and N233R mutations.

14. The detergent composition of claim 1, wherein the detergent composition comprises a polymeric dispersing agent, wherein the polymeric dispersing agent is a polyethylene glycol (PEG) having a molecular weight of from about 500 to about 100,000.

15. The detergent composition of claim 1, wherein the detergent composition comprises a brightener, wherein the brightener is C.I. fluorescent brightener 260 and is in (i) alpha-crystalline form, wherein the alpha-crystalline form is in micronized particulate form, having a weight average primary particle size of from about 3 to about 30 micrometers, or (ii) in beta-crystalline form, or (iii) a mixture thereof.

16. The detergent composition of claim 1, wherein the detergent composition is in a solid form.

17. The detergent composition of claim 1, wherein the detergent composition comprises a fabric hueing agent, wherein the fabric hueing agent is a small molecule dye selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof.

18. A process to clean fabrics, comprising the step of adding the detergent composition of claim 1 to water to make a wash liquor and adding fabrics to the wash liquor.

19. The use of a detergent according to claim 1 for laundering fabrics wherein the fabrics comprise greasy stains.
